(19) United States
(12) Patent Application Publication
(10) Pub. No.: US 2006/0167577 A1
(43) Pub. Date: Jul. 27, 2006

(54) System and method of manufacturing a customized product

(76) Inventors: William Allan Clark, Leyton (GB); Peter Truman, Birmingham (GB)

Correspondence Address: MOTOROLA INC, 600 NORTH US HIGHWAY 45, ROOM AS437, LIBERTYVILLE, IL, 60048-5343, US

(21) Appl. No.: 11/332,446

(22) Filed: Jan. 13, 2006

(30) Foreign Application Priority Data
Jan. 15, 2005 (GB) GB0501542.5

(51) Int. Cl. G06F 19/00

(52) U.S. Cl. 700/97

(57) ABSTRACT

A method of manufacturing customised products comprises automating substantially a process relating to capturing customer requirements, validating customer requirements, generating a component list to manufacture a customised product according to the customer requirements, implementing hardware and/or software requirements relating to the captured customer requirements and manufacturing customised products. In particular, a method of manufacturing a customised product comprises receiving a customer's requirements electronically in a computerised component list format employed by a manufacturer; and automating substantially a process to enable a customised product to be manufactured based on the generated list of components.

### FIELD OF THE INVENTION

The present invention relates to a method and process of managing and controlling a product build. The invention is applicable to, but not limited to, automating a process for customising a product build in accordance with customer requirements.

### BACKGROUND OF THE INVENTION

Manufacturing processes, including product assembly or product configuration, typically comprise the basic steps of:

(i) Receiving an order for a quantity of the product;

(ii) Allocating the materials required for the manufacture of the product for that order; and

(iii) Assigning the order to one or more manufacturing/assembly/configuration lines.

In order for such processes to be efficient, both in terms of time and cost, numerous factors have to be taken into consideration. Such factors may include, by way of example:

(i) Changes to the product and/or materials of the product;

(ii) Non-dedicated manufacturing and/or assembly and/or configuration lines, i.e. where a line may be used for various different products, and therefore requires adapting each time the product being manufactured/assembled/configured is changed; and

(iii) Personnel involved in the process.

In the field of personal computers, Dell™ provide a web-based tool to enable customers to choose from a short menu that list ‘large’ scale (macro) components in order to customize a product being purchased. The components are self contained applications (together with one or two hardware units that are ‘packaged’ together and shipped in a black-box manner, such as a keypad and mouse.

In the field of mobile phone technology, a design concept under-pinning mobile phones designed by Sendo™ is for easy configurability in order to facilitate the Sendo business model of building products that are customised to the requirements of network Operators and end-users. A Sendo handset is therefore required, by design, to be as configurable as is possible.

FIG. 1 is a simplified illustration of a known manufacturer/supplier process 100 for building a product based on received customer requirements.

The process 100 starts with the customer, for example a mobile phone network operator, determining what their requirements are, in step 110. In the second step 120, the customer passes the requirements to the manufacturer/supplier, for example a mobile phone handset manufacturer.

The requirements may include, by way of example only, software and application requirements, colour and other hardware requirements, billing and delivery requirements, etc.

The requirements received from the customer are collated and interpreted 130 by, for example, a sales representative from a local organisation of the manufacturer or supplier.

Once the sales representative has collated and interpreted the customer requirements, the interpreted requirements are typically passed to an order desk, as shown in step 140.

On receiving the interpreted requirements, the order desk formalises the requirements, in step 150. That is to say, the interpreted requirements are entered into, for example, a standard format of the manufacturer's/supplier's internal process flow such as a billing and delivery system etc.

Having formalised the customer's interpreted requirements in step 150, the order desk passes the formalised requirements to the relevant manufacturing/development departments, as shown in step 160.

Next, in step 170, the manufacturing/development departments implement the hardware and software requirements, and create a Bill of Materials (BOM) for the customised product and/or samples of the customised product.

In step 180, the samples are checked to ensure that they fulfil the formalised requirements.

Finally, once the samples have been checked and meet the formalised requirements, the product is built and shipped to the customer 190.

However, the inventors of the present invention have recognised and appreciated that this known prior art has at least one or more of the following disadvantages.

It is often the case that the customer requirements are not passed to the sales representative in step 120 in a single, comprehensive manner. Rather, the requirements may be provided iteratively over a period of time, for example via a product specification containing the basic requirements, followed by subsequent communication in the form of phone calls and emails providing further or more specific requirements.

This creates a problem in that it is necessary for the sales representative to collate all the information received and to try to make sense of the information. Furthermore, it will be necessary for the sales representative to interpret the requirements, thus adding significant subjectivity and potential human error to the capturing of customer requirements.

Furthermore, there is an inherent delay in the process whilst waiting to receive all the requirements from the customer, as well as whilst the sales representative collates and interprets the requirements.

The above problems are further compounded at the order desk. The interpreted requirements received by the order desk, which as mentioned above are prone to subjectivity and human error, must be formalised. This requires the customer requirements to be converted into the format of the manufacturer's internal process flow.

The interpreted requirements received by the order desk are likely to be in a format that is a mixture of the format in which the requirements were received from the customer and that used by the particular sales representative. Therefore, it is possible that this differs significantly to that of the internal process flow.

As a consequence of this, when entering the requirements into the format of the internal process flow, the individual entering the requirements will need to further interpret the requirements in order to best express them in the new format. Consequently, further subjectivity and human error is introduced.

Once again, the need to formalise the requirements adds delay to the process. This delay is further increased since it will be necessary to carry out financial checks, etc. to ensure that the customer has a sufficiently high credit rating and/or has not been “black listed” due to non-payment of invoices, etc. in the past.

It is also necessary to ensure that the requirements received are viable. For example, that all software and hardware components are available/supported by the manufacturer/supplier, and that the specific combination(s) of components is/are valid and without conflict. This viability check adds yet more delay to the process.

As will be appreciated by a skilled artisan, the subjectivity used in interpretation of the requirements at both stages mentioned above can lead to the formalised requirements varying from the original customer requirements to a lesser or greater degree. Furthermore, human error can lead to incorrect values etc. occurring in the formalised requirements.

The outcome of this is that at the validation stage (step 180), the samples etc. are checked against the formalised requirements. Consequently, even if the samples etc. meet the formalised requirements, there is a significant possibility that they may not meet the original customer requirements, due to the subjectivity and human error present in the process.

Yet more delay occurs during the process due to the implementation of the requirements. This is generally performed on an individual basis manually by, in the case of software, manually creating a customised software build. This is then manually tested during validation, which again increases the delay.

This known process also has the disadvantage that it is relatively inefficient in terms of both time and resources, as explained below.

From the point of view of the manufacturer's resources, i.e. actual people required to perform tasks etc., Table 1 below illustrates the resources that may typically be required to handle a simple customer order for a product such as a mobile phone.

TABLE 1
An illustration of the resources that may typically
be required to handle a simple customer order

| Area | Task | Resources |
|---|---|---|
| Sales | Collating and interpreting customer | 1 |
| Representative | requirements | |
| Order desk | Formalising interpreted requirements | 1-2 |
| Manufacturing/ | Implementing H/W and S/W requirements, | 2-4 |
| Development | and creating BOM and samples | |
| Validation | Checking samples fulfil formalised | 1-2 |
| | requirements | |
| Production | Building and shipping customised products | 1 |
| TOTAL | | 6-9 |

Thus, where only customised software components are required, the resources required are likely to be in the range of six personnel. Where both customised hardware and software are required, the resources required are likely to be of the order of at least nine personnel.

The resources indicated for production in Table 1 above only include resources required for ensuring that all of the required information for the building and shipping of the customised product is provided to the factory line etc. It does not include the actual resources required for the building and shipping of the product.

As will be appreciated by those skilled in the art, the need for such high resources adds significantly to the overheads of the manufacturer, which in turn must be passed on to the customer in the price of the product.

There is therefore a substantial need for improving the method and process of managing and controlling a product build to alleviate the above mentioned problems and disadvantages.

### BRIEF DESCRIPTION OF THE DRAWINGS

Exemplary embodiments of the present invention will now be described, by way of example only, with reference to the accompanying drawings, in which:

FIG. 1 is a simplified illustration of a known manufacturer/supplier process for building a product based on received customer requirements

FIG. 2 illustrates a substantially automated control system 200 for managing and controlling the production of a customisable product according to a preferred embodiment of the present invention;

FIG. 3 illustrates an example of a manufacturing system adapted to support the inventive concepts of the preferred embodiments of the present invention; and

FIG. 4 is a simplified illustration of a manufacturer/supplier process for producing a product build based on received customer requirements according to a preferred embodiment of the present invention.

### DESCRIPTION OF PREFERRED EMBODIMENTS

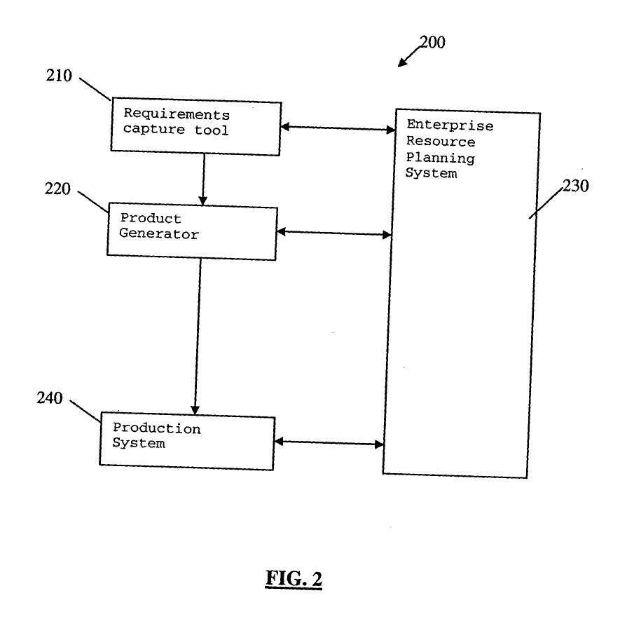

FIG. 2 illustrates a substantially automated control system 200 for managing and controlling the production of a customisable product according to a preferred embodiment of the present invention. Such a control system 200 may be used by a manufacturer/supplier of customisable products, for example mobile phone handsets. The control system 200 comprises a requirements capture tool 210, which is linked to a product generator 220.

The requirements capture tool 210 captures customer requirements, for example the requirements that a mobile phone network operator may have for mobile phone handsets. Such customer requirements may include, by way of example only, software and application requirements, colour and other hardware requirements, billing and delivery requirements, etc.

It is envisioned that the requirements capture tool 210 may comprise an Internet based front-end, whereby a customer is able to directly access the tool via the Internet. In this way, the customer is able to enter the requirements at their own convenience. This has the advantage that it is not necessary for a sales representative to be present whilst capturing and attempting to interpret the requirements of the customer.

In an alternative embodiment, the requirements capture tool 210 may comprise a proprietary software application located on, for example, the computer (e.g. a laptop type computer) of a sales representative of the manufacturer/supplier organisation. In this way, the sales representative can visit the customer and enter the customer requirements with the customer present. This has the advantage of the sales representative being able to answer any questions that the customer might have, or clarify any options available to the customer etc. in a real-time manner.

In a still further alternative embodiment of the present invention, the requirements capture tool 210 may comprise a proprietary software application provided by the manufacturer/supplier to the customer for inclusion on the customer's computer network. Thus, the application can be made available to appropriate personnel of the customer for ordering products, as and when required.

The customer requirements are entered directly into the requirements capture tool 210. Notably, in accordance with the preferred embodiment of the present invention, the customer requirements are entered directly in the format of the manufacturer's/supplier's internal process flow. In effect, the customer requirements are formalised at the point of capture.

As will be appreciated by a person skilled in the art, the use of the requirements capture tool 210 provides a number of advantages over the prior art process.

Firstly, because the customer requirements are entered directly in the format of the manufacturer's/supplier's internal process format, and preferably by the customer him-/herself, problems of:

(i) A sales representative receiving the requirements over a period of time and having to collate the requirements;

(ii) A sales representative having to interpret the requirements received from the customer; and

(iii) The interpreted requirements having to be formalised by the order desk, are overcome. Consequently there is no subjectivity or potential for human error on the part of the manufacturer/supplier that could be detrimental to the accuracy of the formalised requirements.

Furthermore, since the customer requirements are directly entered into the format of the manufacturer's/supplier's internal process format, the time delay inherent in the old system for achieving this is removed.

Once all the customer requirements have been entered, they are “submitted” to the product generator 220. This can be achieved in any suitable manner. For example, in the case of the requirements capture tool 210 comprising an Internet based front-end, the requirements capture tool 210 further comprises a back-end residing on a server. The back-end receives the submitted requirements information, and creates a file containing the captured information. The file may be in any suitable format, for example an extended mark-up language (XML) based format or other proprietary/non-proprietary format. This format can then be sent, or made available, via say a file storage area, to the product generator 220.

For the purposes of the present invention, the terms ‘Front-end’ encompasses Internet-based graphical user interface presented over the (world-wide-web), and ‘back-end’ encompasses a manufacturer/supplier system comprising business logic relating to the products in question, and one or more associated databases.

On receiving the captured customer requirements information, the product generator 220 generates a list of the necessary components to build a product, in accordance with the customer requirements. Such components in particular include, but are not limited to, software binary “images” etc. For physical components such as hardware, etc., the required components are identified so that they can be retrieved from stock.

All parts and components of the product preferably have a unique part number. These part numbers are used to create a bill of material (BOM). The BOM may be generated by the product generator 220, or alternatively by an Enterprise Resource Planning (ERP) System 230. The expression ERP usually applied to corporate software suites, such as SAP™, which are capable of managing all resources of a business in a coordinated fashion, covering: physical items such as the management of stock components, purchasing and production, sales and shipping. In addition, an ERP system may also encompass monetary items such as payment and billing, cash management etc. as well as Human resources functions from recruitment to payment.

Having generated the necessary components, the product generator 220 makes the components available to a production system 240. For example, software components may be made available by storing them in a file storage area. The production system 240 is then able to use the generated components to build and ship the customised product.

In a preferred embodiment of the present invention, prior to the necessary components being made available to the production system 240, the software components are tested to ensure that they function as intended/required.

The product generator 220 may generate these test scripts, which are based on the software components. Alternatively, a separate tool (not shown) may generate the test scripts based on the customer requirements.

The software components and the test scripts can then be provided to a device emulator (not shown), which emulates a device onto which the software components are to be loaded. The test scripts are then preferably run on the emulator to ensure that the software behaves as expected.

The control system 200 further comprises an enterprise resource planning (ERP) system 230. The ERP system 230 is preferably coupled to each of the requirements capture tool 210, the product generator 220 and the production system 240.

An example of a suitable ERP system is SAP™, details of which can be obtained from www.sap.com.

The ERP system 230 preferably holds, and controls, information regarding available options for customising a product. By way of example, for electronic products containing embedded software such as a mobile phone handset, the ERP system 230 contains details of available software features and/or functionality, including details regarding compatibility between, and requirements for, different features and functionality within the product. In this way, the requirements capture tool 210 is able to obtain such information from the ERP system 220, and only allow a user to customise a product in a valid/allowable manner. This may be achieved by the requirements capture tool 210 interrogating the ERP system 230, either periodically or as and when required.

Alternatively, the ERP system 230 may “push” the information to the requirements capture tool 210, for example whenever new information is available.

The ERP system 230 preferably also holds, and controls, information regarding users of the system. For example, the system may be restricted to previously approved users, such as network operators. In order for a customer to use the system, it is necessary for the customer's details to have been entered on the system.

This would allow only users who have a sufficient credit rating or the like to make use of the system, as well as aiding in preventing random, incorrect and/or inappropriate use of the system, which could tie up computing resources etc.

In an advanced embodiment of the present invention it is envisaged that the requirements capture tool 210 provides for different types of user, such as customers, consumers and internal users (e.g. employees of the manufacturer/supplier organisation).

For example, customers such as network operators might have an on going relationship with the manufacturer/supplier. In this way, the customer and the manufacturer/supplier would have previously negotiated certain terms such as pricing, certain settings, graphics and logos, minimum quantities and other standard requirements that the customer might have. It is envisaged that this information can be held within the ERP system 230. When the customer logs onto the system, for example by way of a unique username and password, the previously agreed details can automatically be retrieved from the ERP system 230. Thus, this saves the need for the customer to re-enter such details each time they use the system.

Consumers on the other hand will in general only make one off purchases. Therefore, they will not have negotiated such terms or requirements, etc. with the manufacturer/supplier. Therefore, it will be necessary for a consumer to enter all of the required information. However, it is envisaged that a consumer might be provided with fewer customisation options, as certain options may require either a certain level of technical understanding, or a minimum quantity purchased to make those options financially viable. Furthermore, consumers may be limited to maximum quantities as a consumer is likely to have a lower credit rating than, say, a network operator.

Furthermore, it is envisaged that internal users may be provided with discounted prices, for example as part of an employee benefit package. Alternatively, internal users may be able to make use of the system for ordering samples, which may be required for trade shows to show to prospective new customers, or simply to test new products.

The ERP system 230 preferably also holds information regarding stock levels, lead times for ordering new stock etc., for example the information provided by the production system 240. Furthermore, the ERP system 230 preferably also monitors production orders already scheduled on the production system 240. In this way, it is possible to determine the earliest possible delivery dates for products depending upon the requirements entered by a user of the system, based on availability of stock and when the product can be scheduled to be built. Consequently, a user can be provided with an estimated delivery date, or be able to select a favourable delivery date from a range of possible delivery dates.

It is also envisaged that the ERP system 230 may also store details regarding usage of the system. For example, the ERP system 230 stores the time and date that a user logs onto the system.

Furthermore, it is envisaged that the requirements capture tool 210 allows a user to “save” a session, for example during entering their requirements, a user may need to leave and come back at a later time to finish entering the requirements. When this is the case, the user is able to save the session, and thereby save the requirements entered up to that point. In this case, the requirements capture tool 210 preferably sends the entered requirements to the ERP system 230, which stores the information. The next time that user logs on to the system, the requirements capture tool 210 is able to retrieve the information from the ERP system 230, thus saving the user from having to re-enter the information.

As previously mentioned, the product generator 220, on receiving the customer requirements, generates (or identifies) the necessary components for the customised product to be built.

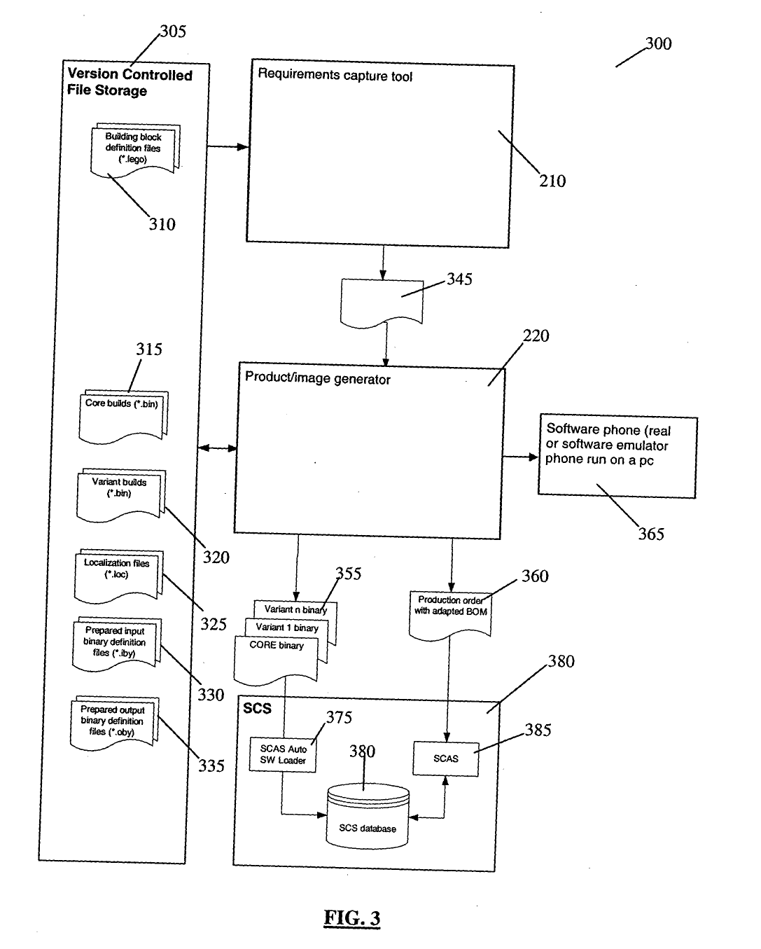

From the point of view of software components, the product generator 220 preferably generates, for example, software binary “images” containing the required features/functionality/applications etc. This is described in more detail later in the description, with reference to FIG. 3.

From the point of view of hardware, it is envisaged that a user's requirements includes the selection of possible hardware options. For example, where the product is a mobile phone handset, the user of the system may be able to select the base model, the colour of the handset, the type of camera (e.g. the resolution/number of pixels), etc. Where this is the case, it is not necessary for the product generator 220 to generate any components. Instead the relevant part numbers for the selected hardware components are simply included in the BOM, as mentioned above.

However, it is also envisaged that a user's requirements includes hardware options that are not necessarily standard. For example, a mobile phone network operator may specify that their logo or some other graphic be present on, for example, the bezel of the handset. Thus, where this is the case, the user (customer/consumer or other) is able to input directly their customised requirements to be introduced directly onto their designed product(s).

Where this is the case, the product generator 220 preferably generates a print template, or other appropriate guide/specification, which is preferably automatically sent to the supplier of, in this example, the handset bezels, along with the required quantity of bezels. Alternatively, the print template, or other appropriate guide/specification, may already exist, for example from a previously placed order or from prior negotiation, and stored in the ERP system 220. In this case, the product generator simply retrieves the print template or other appropriate guide/specification from the ERP system 230, and the required bezels, comprising the network operator logo, are automatically ordered from the relevant supplier.

This may also apply to packaging, manuals, marketing/advertising material etc.

As also mentioned above, every component of a product is allocated a unique part number. All part numbers are preferably held and controlled in the ERP system 230. The product generator 220 preferably creates a complete list of all components to be used in a product.

In one embodiment of the present invention, the product generator will then pass the list to the ERP system 230, which for the known or previously used/generated components retrieves the relevant part numbers. For new components, such as specifically-generated components, the ERP system 230 creates new part numbers.

The ERP system 230 then uses the part numbers to create the BOM for that product, which it stores and also preferably passes back to the product generator 220. The product generator 220 is then able to make the components and their part numbers available to the production system 240.

In an alternative embodiment, the product generator 220 retrieves the part numbers for the known or previously used/generated components from the ERP system 230. For the new components, the product generator 220 creates the new part numbers. The product generator 220 is then able to create the BOM itself, which it passes to the ERP system 230 for storing, along with the newly created part numbers. The product generator 220 is then able to make the components and their part numbers available to the production system.

The production system 240 is provided with the BOM, identifying all required components, along with the quantity of units to be built and the delivery information. From the BOM, the production system 240 is able to generate a “pick list” or the like, which lists all the physical components (e.g. hardware, accessories, user manuals, packaging, etc.) required to build the product, and the quantities required to fulfil the order. This pick list can then be used to retrieve all necessary physical parts from stock.

Furthermore, the production system 240 is able to identify from the BOM all necessary software files (e.g. binary images, resource files, etc.), which will have previously been made available by the product generator 220. The production system 240 can then retrieve the required software files, and configure the assembly line for downloading the files into the units as they are built.

A user of the system is, in effect, placing an order each time they submit their requirements. Preferably the ERP system 230 tracks the progress of each order. Furthermore, it is envisaged that the ERP system 230 effectively and automatically without human intervention controls the process, allowing each order to progress through each stage, or restricting orders from progressing if required.

For example, when an order is placed (i.e. a user submits their requirements), the requirements capture tool 210 sends the customer requirements to the product generator 220, as well as informing the ERP system 230 of the placing of an order. The product generator 220 waits until it receives confirmation from the ERP system 230 before generating the required components.

Alternatively, on receiving the customer requirements from the requirements capture tool 210, the product generator 220 notifies the ERP system 230 of the receipt of an order, and awaits confirmation to proceed from the ERP system 230 before generating the required components.

Thus, on receiving the notification from the requirements capture tool 210, the ERP system 230 performs a check to ensure that it is acceptable to process an order from that particular user. For example, where the user is a customer such as a network operator, each customer may be associated with a credit limit. The ERP system 230 checks the current credit level for that customer, and if the customer is within their limit, the ERP system 230 will signal the product generator 220 to proceed with generating the required components.

Alternatively, the ERP system 230 may contain, or have access to, a list of customers who have outstanding unpaid invoices or the like. If the user is on this list, the ERP system 230 may then automatically send a notice (for example by email) to the user informing them that until the outstanding invoices have been paid no more orders will be accepted. The order is then “held” without further progress until the outstanding invoices are paid, or the order is cancelled.

Alternatively, it may be that payment for an order is due prior to an order being fulfilled. In this case the ERP system 230 awaits confirmation that a payment has been received before instructing the product generator 220 to proceed with generating the required components.

In this manner, the product generator 220 only generates required components for ‘valid’ orders, with the ERP system 230 performing certain checks prior to committing to the work. This has the advantage that computing resources and the like are not wasted on generating components for orders that are not fulfilled.

The ERP system 230 preferably also controls the scheduling of product builds. For example, the ERP system 230 may monitor stock levels, and allocate stock to specific orders. When all components for a particular product order are available, the ERP system 230 schedules or causes to be scheduled the building of the product order with the production system 240.

In this manner, it is possible to cancel any order, for example if parts become unavailable or a customer wishes to cancel the order, with minimum interference to the production system 240. This allows the production system 240 to operate as efficiently as possible, and thereby aids in achieving maximum productivity on the assembly lines, etc. This is an important advantage since any confusion or delays that might occur on an assembly line (or the like) can result in significant drops in productivity and thereby lost revenue.

Once a product has been built and shipped, the production system 240 preferably confirms shipment to the ERP system 230.

The ERP system 230 preferably also contains pricing information for each product/order, which preferably is provided by the requirements capture tool 210 or product generator upon submission of the customer requirements (since the user would preferably have been informed of the price prior to submitting the order).

Alternatively, the ERP system 230 may calculate the price from the BOM. This can be achieved simply by associating each part number with a price. In this way, the ERP system 230 can simply total all of the individual component part prices (with appropriate margins and other cost factors such as profit taken into account) to obtain the overall price.

Where new components are generated, at the time of assigning new part numbers, the price for each new component can be determined based on the contents of each component, or based on the price of alternative like components.

In either event, the ERP system 230 possesses both the price (per unit) and the quantity of units shipped. Consequently, the ERP system 230 is able, upon confirmation of shipment, to automatically generate, or cause to be generated, invoices, etc. as appropriate.

Notably, the system is able to provide “weighted/variable costings” dependent upon the software assembly work required, and software components utilised in a products final configuration. Thus, the ERP system has been adapted to produce customised BoMs (from template BoMs), which will include the user's constructed software and required hardware elements. Preferably, these BoMs are internally checked (as each component must be valid and able to be used) before it can be approved and sent for construction. Thus, the preferred embodiment of the present invention automates the current manual process of BoM construction for each customer product, and can advantageously highlight potential discrepancies accordingly.

Referring now to FIG. 3, the process of generating a product preferably uses “building blocks” in order to represent the hardware and software domains. In particular, in the context of the present invention, embedded software elements of the product are represented as software building blocks. Embedded software elements, in the context of the present invention, comprise software modules where software-based functions of an electronic product, such as a mobile phone, are separated into code and data (i.e. software that is not ‘execute’ by a processor). In particular, the inventive concept configures how the code modules execute in a product being manufactured by changing the data. Thus, a tool is provided that allows configuration to be performed in a well-defined, automated manner.

Notably, the configuration is performed safely (i.e. inconsistencies between software modules are avoided). This is advantageous when configuring complex embedded software-based products due to the huge number of product variations that can be ultimately manufactured. Thus, a standardised process of driving down customisation throughout the embedded software contained within a product is supported. Such concepts are described in a co-pending UK patent application by the same Applicant (Applicant's reference P394 filed in January 2005).

In this way, the requirements capture tool 210 is able to provide a user (e.g. a customer, consumer, sales representative, etc.) with the opportunity to effectively “click” together a working device from preferably a mixture of embedded software and additional hardware components. The embedded software is such that a user “clicks” together a working software domain (hereinafter referred to as “image”) comprising, for example, an operating system (OS) and/or one or more applications and/or one or more settings and/or one or more resources to fit that phone.

Notably, it is within the contemplation of the present invention that the customisation of a software-based electronic product may encompass every aspect of the product, in addition to the embedded software elements.

Thus, in the context of the present invention, it is envisaged that the embedded software may be configured to represent further elements in addition to the software elements, for example representing at least:
(i) One or more hardware elements; and/or
(ii) One or more packaging elements; and/or
(iii) One or more accessories.

As such, it is envisaged that the customisation of the software-based electronic product may encompass the box that the product is shipped in, for example, its size, shape, colour, logo affixed to the box or the product, any manuals that accompany the product, options for accessories, such as cables, battery chargers, replacement batteries, etc. for a phone product.

Referring now to FIG. 3, a preferred implementation of the system architecture 300 is illustrated in more detail. The system architecture 300 is configured to control the complete configuration process for, say, the build of a Smartphone, i.e. a new generation of mobile phone that supports. The preferred system architecture 300 comprises a version-controlled file storage function 305, which for the preferred embodiment of the present invention forms a part of the ERP system 230.

The version-controlled file storage function 305 comprises the necessary software and hardware building blocks 310, comprising core building blocks 315, variant builds 320, localisation files 325 and binary definition files 330, 335. In the preferred embodiment of the present invention, the version-controlled file storage function 305 comprises, say, hundreds or thousands of software and/or hardware building blocks. Each block is also preferably provided with its own unique part number.

The version-controlled file storage function 305 is operably coupled to the requirements capture tool 210 and the product generator 220. A customer preferably accesses a user interface (UI), or graphical UI (GUI) (not shown) of the requirements capture tool 210. When ‘building’ a graphical representation of the electronic product, the requirements capture tool 210 accesses representations of the embedded software and preferably hardware building blocks stored in the version-controlled file storage function 205.

The output of the requirements capture tool 210 is preferably a “definition” file 345 containing all of the customer requirements. The definition file 345 of the device (that includes both hardware and software components, packaging and accessory components, billing and delivery information, etc.) will preferably comprise all information regarding the device, at all levels. This file could, in theory, be regarded as the “recipe” for the construction of the device. The definition file 345 may take any suitable form, for example the definition file 345 may be in the form of a mark up language file, such as an adaptation of XML.

Since the user (e.g. the customer or consumer) has defined the device's requirements, including preferably its look and feel, it is possible to generate a set of scripts for use by a test (harness) engine (not shown), to ensure that the end product that is produced matches the customer requirements, as provided directly by the customer.

In combination with the assembly database (validation), this dramatically reduces the requirements for test and delivery of a product to a customer. Furthermore, as the subjectivity and potential human error factors that are inherent in the prior art process have been substantially removed, the testing is performed directly against the customer requirements. This significantly improves the quality (from the customer's point of view) of the delivered product.

The definition file 345 is passed from the requirements capture tool 210 to the product generator 220. The product generator 220 uses the information contained within the definition file to generate a set of software image components to be loaded onto a device. These components are issued unique part numbers and are preferably included, along with the part numbers of all other components of the device, into a bill of material (BOM) 360.

The BOM 360 can then be passed to a production system 380, for example the production system 240 of FIG. 2, for actual construction on the assembly line.

The production system 380 preferably comprises a configuration administrative system automatic software loader 375, for configuring the product with selected software elements, such as applications. The selected software code/applications are then preferably extracted from a configuration system database 380.

For the purpose of configuring a Smartphone build, it is envisaged that the product generator 220 may generate a production order with an adapted BOM 360. In an enhanced embodiment of the present invention, the adapted BOM may be used to emulate in software the operation of the Smartphone, for example, to be run on a real-life phone or on a personal computer (PC) or a networked computer 365. Again, the aforementioned test scripts can again be used to provide a test environment for the product at a virtual stage, before committing build resource.

Advantageously, with the provision of an emulator according to the enhanced embodiment of the present invention, the preferred solution may be iterative, i.e. a customer or consumer can assess the various selectable hardware and/or software options from the version-controlled file storage 305 and assess their impact in a real-life scenario, in a real-time manner, as more embedded software elements are incorporated into the emulated phone. Thus, an iterative solution may be used to ensure consistency across various software/hardware versions of phones being manufactured.

This virtual device may also be presented during creation and configuration, so that a user can visualise and interact with a virtual representation of their product.

It is envisaged that the BOM 360 may also comprise a list of parts, with new additional information relating to a particular product build. Preferably, the BOM 360 may also comprise a favourite list of selectable hardware and/or software elements contained, say, in a browser.

A further advantage of the inventive concept hereinbefore described is that it is far easier for manufacturers and customers/consumers to collaborate on joint development work. In particular, the implementation is preferably web-based, to allow, for example, a Smartphone manufacturer to work with customers/consumers or vendors in an on-line manner.

In addition, it is envisaged that the aforementioned arrangement may be used as part of various project management exercises, in the development of products. That is, in this manner, a development or project engineer or manager is able to validate the inter-working of particular software and preferably hardware components more easily during a development phase of the product.

The Variant builds 320 preferably contain order/customer specific information and comprise the configurable software items for the Smartphone. Thus, the product generator 220 is used by the customer to combine software and/or hardware building block representations, based on the core building blocks 315, and one or more variant builds 320, localisation files 325 and binary definition files 330, 335. Preferably, the product generator 220 also specifies a particular version of the build environment that is to be used/being used.

The requirements capture tool 210 preferably also provides an object representation of configurable elements in the build environment. As such, the requirements capture tool 210 comprises software and preferably hardware representations of product elements, such as mobile phone elements. In an enhanced embodiment of the present invention, the software representation comprises embedded software elements, so that a mobile phone can be designed/built from these embedded software elements. Preferably, the embedded software elements are stand-alone items that may be configured within a phone, say, in a ‘plug-in’ type manner.

As previously mentioned, it is envisaged that the software build can be performed over the Internet, through a client application or by another system or via a customer's system. Furthermore, it is envisaged that a new application can be added as an option on the requirements capture tool 210, as a new isolated module (for example in the form of a Java bean) that describes both the application and its configuration relevant behaviour.

In this form, the customer or consumer is able to manipulate the requirements capture tool 210 elements, in effect by performing a drag and drop and verify operations. The build environment/product generator 220 is modified to deal with the application object, which preferably does not require extensions and/or modifications to many, if any, different parts of the build environment.

A hardware or software component object in the requirements capture tool 210 should preferably be an object in the build environment. If the software component object cannot be the same as the object in the build environment, then the match should be as close as possible.

Example software candidate for representing these embedded software elements is C++ or JAVA. The classes of configurable elements are preferably equipped with a subset of the behaviour methods of matching Java beans in the requirements capture tool 210, as will be appreciated by a skilled artisan. It is envisaged that a JAVA based arrangement provides the simplest and most efficient mechanism to implement a ‘drag and drop’ function within the requirements capture tool 210.

In addition, it is envisaged that other advantageous methods may be supported using C++ classes, which are particularly applicable in a build environment. It is also envisaged that the classes in the build environment may comprise additional levels that are built into the software to handle more detail-specific builds.

A listing of various software configurable (selectable) elements, as used in the preferred embodiment of the present invention, comprises:

(i) Customer variant elements—Contains customer specific Bitmaps, splash screens, ring tones, etc.;

(ii) Customer Applications variant elements—Contains customer specific applications;

(iii) Language variant elements—Contains a set of languages with a specified default language; and

(iv) Specific applications, such as logos, bitmaps, splash screens, ring tones, etc.

Furthermore, it is envisaged that a listing of various hardware configurable elements, as used in the preferred embodiment of the present invention, may comprise, for example:
(i) Battery type;
(ii) Bezel; and
(iii) Labels.

A skilled artisan will appreciate that many other variant/selectable elements may be offered in alternative applications.

Downloading of binary files to a Smartphone build is preferably performed using a universal serial bus (USB), or by use of a removal memory module (such as a memory card), which is used for conventional programming of mobile phones.

Although the present invention has so far been described as primarily allowing either a customer or a sales representative being able to utilise the features and functionality of the present invention, it is contemplated that the requirements capture tool 210 may also be made available to consumers. In this way, a consumer is able to order a customised single unit to their requirements. Alternatively, a consumer may be able to select/configure software upgrades, additional software applications, accessories, etc. for a previously purchased product.

In accordance with a preferred embodiment of the present invention, an input for the requirements capture tool 210 is preferably a Customisation Checklist, as completed by the customer or consumer. Customisation of a Smartphone, as specified by the customer or consumer, may require changes to a configuration, depending upon, say, a rules database (not shown) for the requirements capture tool 210. For instance, the consumer or customer may be provided with the opportunity to specify a combination of two applications where the rules database specifies that these applications typically cannot be used together, for example due to incompatibilities between the two applications. This means that the customer will have to change his/her requirements.

The preferred embodiment of the present invention envisages that the customer is provided with the ability to specify several ‘application’ items of the user interface of the Smartphone, which are preferably configured/arranged to be customisable, by the end user. These items comprise:

(i) Background bitmaps;

(ii) Colour schemes;

(iii) Sounds;

(iv) Animations;

(v) Fonts; and

(vi) Indicators such as Key-lock, GPS signal, etc.

The customer is preferably also provided with an opportunity to specify his/her own splash screen, i.e. the initial screen that appears for a few seconds following start-up, as well as specify how long the splash screen is to be displayed. In addition, the customer is preferably also provided with an opportunity to specify one or more customer-specific ring tones to be loaded into the phone.

It is envisaged that the customer is preferably also provided with an opportunity to specify items that are specific for use in a particular country or region, in relation to the manufacture/build of a particular order. For example, the customer may specify:

(i) One or more languages, where the number of specified languages is limited by the amount of memory used by the total build;

(ii) A default language, if more than one language is specified. Advantageously, this allows the Customer to order a single phone capable of operating in two different countries, where the phone starts up with the default language for the correct country in which the phone was sold; and

(iii) Default regional settings to control, for example, a display of date and/or time in the correct format for the specified region, and/or a display of currency/numbers, etc. in a correct format for the specified region and/or a default time zone, etc.

It is also envisaged that the customer is provided with the opportunity to define the connection settings for each phone from, say, a list of connection types that are supported by the phone, to match the customer's setup. Such connection settings may include one or more of the following:

(i) Wireless Access Protocol (WAP) parameters, where all WAP connection settings are specified in the WAP provisioning Content Specification, available from the WAP Forum (http://www.wapforum.org);

(ii) General Packet Radio System (GPRS) parameters;

(iii) Dial-up settings and parameters;

(iv) Browser settings, including browser favourites. Here, the Customer is preferably provided with the opportunity to define a list of browser favourites to be pre-configured in the phone for a particular order. The definition of a browser favourite will preferably include at least a descriptive tag and the URL. Additionally, the Customer is preferably able to specify a sequence in which the Browser favourites appear;

(v) Proxy settings and parameters; and

(vi) Over-the-air programming (OTAP) mechanisms.

In an enhanced embodiment of the present invention, it is envisaged that the product generator may be expanded with a Graphical User Interface (GUI). This GUI is preferably configured to allow the Customer to enter the information from the Customisation checklist. The GUI application then outputs a BOM, limited to only the build specific information. In this manner, the product generator set-up can be used and tested before the requirements capture tool is put in place.

Advantageously, the aforementioned build mechanism enables the phone binaries to be built by someone who is not technically proficient, thereby enabling orders for the phone to be fulfilled in a customisable manner.

Thus, an image may be generated in a post manufacturing process step in a distribution/retail context using a plurality of selectable software representation blocks

In addition, it is possible for customer specific components to be incorporated, without the need for the customer to manually specify them. For example, in the above example, the resource files of the product may include customer specific graphics and logos. Such logos have preferably been previously arranged and agreed with the customer, for example from previous orders and/or negotiations.

In this manner, the order information may comprise a customer identifier for a particular software-package option. Thus, the part number for the software-package option may be specific to Customer ‘X’.

As previously mentioned, the order for an electronic product, particularly when placed by a customer such as a network operator, may encompass a large number of products. Sets of these products may be configured in substantially the same manner or some may be configured with individual requirements.

It is within the contemplation of the invention that the inventive concepts hereinbefore described are not limited to the described Smartphone software build or associated manufacturing system of the preferred embodiment. Indeed, it is envisaged that the inventive concepts are applicable to any suitable mass-produced product, particularly a software-based electronic product (or product that offers software variants) comprising embedded software and preferably hardware elements.

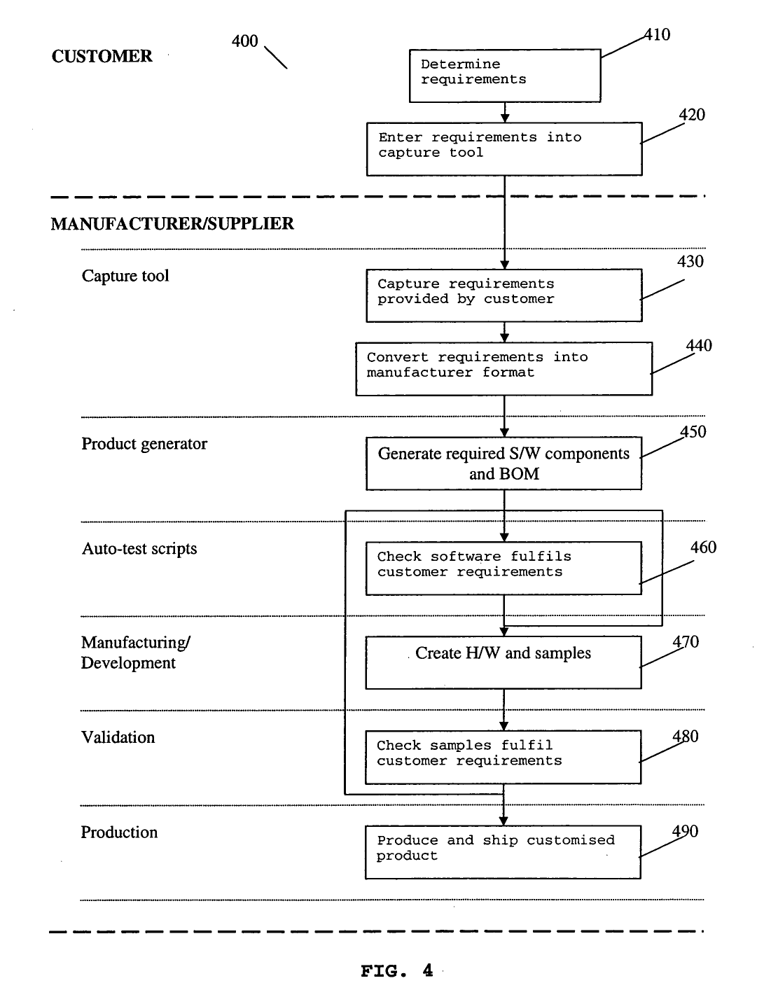

FIG. 4 is a simplified illustration of a manufacturer/supplier process 400 for producing a product build based on received customer requirements according to a preferred embodiment of the present invention.

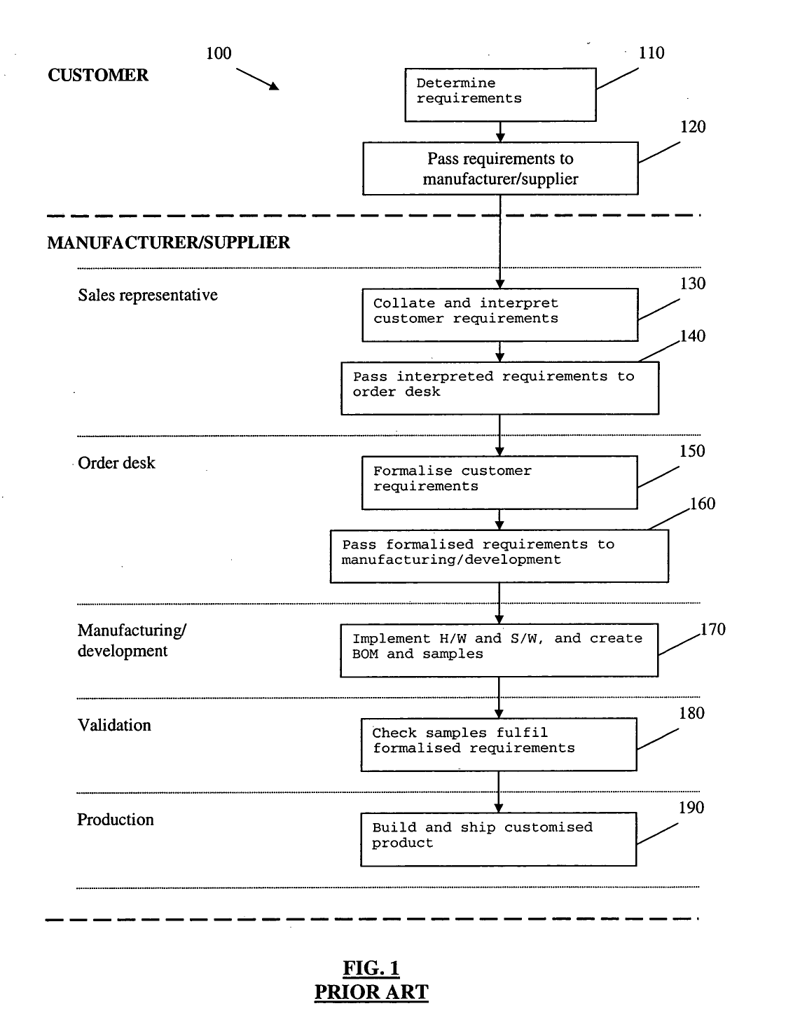

As with the prior art process 100 illustrated in FIG. 1, the process 400 according to a preferred embodiment of the present invention begins with a customer (or other user of the system such as a consumer or employee of the manufacturer/supply organisation) determining their requirements, in step 410. Next, the customer enters the requirements into the requirements capture tool (say requirements capture tool 210 of FIG. 2), as illustrated in step 420. Preferably the requirements capture tool is configured such that the requirements are entered directly into the format of the internal process flow of the manufacturer/supplier.

As will be appreciated by a skilled artisan, by the customer requirements being entered directly into the requirements capture tool 210 by the customer in the format of the internal process flow of the manufacturer/supplier, the subjectivity and potential for human error on the part of the manufacturer/supplier that afflicts the prior art process illustrated in FIG. 1 is substantially alleviated.

Furthermore, it is not necessary for either a sales representative to manually collate the customer requirements, or for the interpreted requirements received from a sales representative, to be manually formalised. Consequently, the inherent delays relating to these steps in the prior art process illustrated in FIG. 1 are substantially removed.

In step 430, the requirements capture tool captures the requirements provided by the customer, in step 430. In step 440, the requirements capture tool then makes the requirements available to a product generator (say the product generator 220 of FIG. 2) in a suitable format.

In step 450, the product generator generates required software components and preferably creates a Bill of Materials (BOM). In an alternative embodiment, the BOM is created by an enterprise resource planning system, such as the ERP system 230 of FIG. 2, based on a list of components provided by the product generator 220 of FIG. 2.

In step 460, the software components generated by the product generator are tested using automated test scripts on a product emulator (not shown). The test are preferably automatically generated based on the captured requirements, and may be generated by the product generator or by a separate test script generator. The criteria for the tests more accurately represent the requirements of the customer compared to the prior art process of FIG. 1, since the test scripts are based directly on the requirements provided by the customer.

The software components and test scripts are preferably automatically loaded into the emulator, and tested, to ensure that the software fulfils the customer requirements.

Where the customer requirements only require customised software components, once the software components have been tested using the test scripts, no further testing or validation is required. Thus, the software components and the BOM etc can be made available to a production system, say the production system 240 of FIG. 2. Thus the next step 490 is simply for the product to be produced and shipped to the customer.

From a manufacturer's required resource perspective, i.e. actual personnel required to perform tasks to support the inventive concepts of the processes hereinbefore described, Table 2 below illustrates the required resources.

TABLE 2

| Area | Task | Resources |
|---|---|---|
| Capture | Capturing customer requirements | 0 |
| tool | | |
| Product | Generating required software components | 0 |
| Generator | and BOM | |
| Auto-test | | |
| scripts | | |
| Production | Building and shipping customised products | 0 |
| TOTAL | | 0 |

The resources indicated for ‘production’ in Table 2 above only include resources required for ensuring all of the required information for the building and shipping of the customised product is provided to the factory assembly line, etc. Thus it does not take into account the actual resources required for the building and shipping of the product.

As can be seen, the present invention provides a system whereby it is possible for an order to be received (i.e. when a customer enters their requirements) and fully processed through to production without any human intervention or requiring human resources. In comparison, the prior art process of FIG. 1 requires around six personnel.

As will be appreciated by those skilled in the art, this substantial reduction in resources significantly reduces the overheads of the manufacturer, which in turn can be passed on as a saving to the customer in the price of the product. Alternatively, the reduction in overheads can free up finances that can be put into other areas of the business, such as research and development, etc.

Referring back to FIG. 4, where customised hardware components are required, there are the additional steps of creating the required hardware components and samples in step 470 and checking the samples fulfil the customer requirements in step 480.

From a manufacturer's required resource perspective, i.e. actual people required to perform tasks, etc., Table 3 below illustrates the required personnel to carry out the tasks described above.

TABLE 3

| Area | Task | Resources |
|---|---|---|
| Capture tool | Capturing customer requirements | 0 |
| Product | Generating required software components | 0 |
| Generator | and BOM | |
| Auto-test | | |
| scripts | | |
| Manufacturing/ | Implementing H/W requirements, | 2 |
| Development | and creating samples | |
| Validation | Checking samples fulfil customer | 1 |
| | requirements | |
| Production | Building and shipping customised products | 0 |
| TOTAL | | 3 |

The resources indicated for production in Table 3 above only include resources required for ensuring that all of the required information for the building and shipping of the customised product is provided to the factory assembly line, etc. Thus, it does not include the actual resources required for the building and shipping of the product.

As can be seen, the present invention provides a system whereby it is possible for an order to be received (i.e. when a customer enters their requirements) and fully processed through to production requiring only three personnel. In comparison, the prior art process of FIG. 1 require around nine personnel (human resources), thereby highlighting the significant advantages that can be gained by incorporating a fully functional automated and interlinked operation throughout a whole customised product build process.

Once again, this substantial reduction in personnel/human resources significantly reduces the overheads of the manufacturer, which in turn can be passed on as a saving to the customer in the price of the product. Alternatively, the reduction in overheads can free up finances that can be put into other areas of the business, such as research and development, etc.

In summary, it can be seen that substantially a whole business structure can be adapted to support the manufacture of a customised product, by incorporating substantially all business functions into a software process that can be automated and managed as a single entity. Thus, the automation process supported by the integrated nature of the customisation and configuration of products as described above, from sales through order entry through manufacture through stock control through BoM generation through testing and validation through to product shipment and billing, etc. revolutionises how a business operates. Thus, each and every business function is adapted (if at all possible) to be integrated into the automation methodology described above.

In practice, it is likely that the manufacturer/supplier organisation will require an additional resource to maintain a system according to the present invention, for example the control system 200 for managing and controlling the production of a customisable product. However, even with this additional resource, the overall resources required are significantly less than that required by the prior art system.

It will be understood that the control system, as described above, tends to provide at least one or more of the following advantages:

(i) Removes delay in the processing of orders for customised products;

(ii) Reduces subjectivity and human error in capturing and fulfilling customer requirements;

(iii) Reduces the amount of resources required in processing orders for customised products, resulting in:
1. economic savings; and/or
2. freeing up resources for other tasks.

(iv) Facilitates the ordering of new products from a customer's/consumers perspective, thereby improving saleability of products;

(v) Allows a simple and effective way for employees of the manufacturer/supplier organisation to obtain products for:
1. personal use (for example as part of an employee benefit scheme)
2. samples to show to prospective customers or at trade shows, etc.

(vi) Provides a repeatable, and therefore controllable process, which allows for improved quality control, which in turn allows for:
1. higher quality of products; and
2. customer confidence.

Overall, the present invention provides an automated customisable product system that allows for a more efficient and effective method of business, and can form an integral part of the running of a business. Thus, the whole operation of the business is dictated to by the automation and integral working of the separate functions

Whilst the specific and preferred implementations of the embodiments of the present invention are described above, it is clear that one skilled in the art could readily apply variations and modifications of such inventive concepts.

Thus, an improved control system for managing and controlling the production of a customisable product and method therefor has been described where at least one of the aforementioned disadvantages with prior art arrangements has been alleviated.

1. A method of manufacturing customised products including the steps of automating a process relating to capturing customer requirements, validating customer requirements, generating a component list to manufacture a customised product according to the customer requirements, implementing hardware and/or software requirements relating to the captured customer requirements and manufacturing customised products.

2. A method of manufacturing a customised product, the method characterised by the steps of:
receiving a customer's requirements electronically in a computerised component list format employed by a manufacturer; and
automating substantially a process to enable a customised product to be manufactured based on the generated list of components.

3. A method of manufacturing a customised product according to claim 1 wherein the step of automating includes automating the entire process from a customer entering their requirements electronically to the build of a customised product.

4. A method of manufacturing a customised product according to claim 1 wherein the step of receiving a customer's requirements comprises capturing the received customer's requirements electronically and automatically converting the received customer's requirements into a computerised component list in a format employed by the manufacturer.

5. A method of manufacturing a customised product according to claim 4 wherein the step of automatically converting comprises converting the received customer's requirements into a format employed by the manufacturer and generating a computerised component list based on the converted customer's requirements.

6. A method of manufacturing a customised product according to claim 5 wherein the step of generating a computerised component list incoudes generating a bill of materials for the customised product to be built.

7. A method of manufacturing a customised product according to claim 4, wherein the step of receiving a customer's requirements electronically comprises the customer entering their respective requirements directly onto the manufacturer's requirements capture tool for generating customised products.

8. A method of manufacturing a customised product according to claim 4 wherein the step of automatically manufacturing a customised product based on the generated list of components comprises automatically creating a sample of the customised product built according to the customer's requirements and testing the sample against the received customer's requirements.

9. A method of manufacturing a customised product according to claim 1 further including the step of validating a customer prior to the step of automatically manufacturing a customised product based on the generated list of components.

10. A method of manufacturing a customised product according to claim 1 further including the step of validating the stock of required components prior to the step of automatically manufacturing a customised product based on the generated list of components.

11. A system for manufacturing a customised product comprising:
a customer requirements capture tool arranged to receive a customer's requirements electronically and automatically create in response thereto a computerised component list format employed by a manufacturer; and
a product generator operably coupled to the customer requirements capture tool and arranged to automatically generate a list of components in a computerised component list format employed by a manufacturer in response to the electronic customer's requirements; and
a production system operably coupled to the product generator and arranged to build the customised product.

12. A system for manufacturing a customised product according to claim 11 wherein a resource planning system is operably coupled to the customer requirements capture tool, product generator and production system and arranged to control an automatic manufacture of the customised product from receiving a customer requirements through to manufacture.

13. A system for manufacturing a customised product according to claim 12 wherein the resource planning system comprises information on compatibility between components to validate that the customised product can be built.

14. A system for manufacturing a customised product according to claim 12 wherein the resource planning system is interrogated periodically for compatibility information by the requirements capture tool to prevent the customer from entering an invalid set of components.

15. A system for manufacturing a customised product according to claim 12 wherein the resource planning system maintains stock information relating to the product that can be customised.

16. A system for manufacturing a customised product according to claim 12 wherein the planning system schedules the building of the customised product order with the production system.

17. A system for manufacturing a customised product according to claim 12 wherein the resource planning system automatically controls the process of manufacturing a customised product without human intervention.

18. A system for manufacturing a customised product according to claim 12 further characterised in that the resource planning system comprises a pricing function to provide a cost for the components required to build the customised product.

19. A system for manufacturing a customised product according to claim 11 wherein the list of components includes a box that the product is shipped in including logo affixed to the box, a manual to accompany the product, and accessories.

20. A system for manufacturing a customised product according to claim 11 wherein the product generator comprises an interface mechanism for a customer to enter their own customised information onto a product to be built.
